(19) United States
(12) Patent Application Publication
(10) Pub. No.: US 2016/0098110 A1
(43) Pub. Date: Apr. 7, 2016

(54) DISPLAY DEVICE INCLUDING TOUCH SENSOR

(71) Applicant: Samsung Display Co., Ltd., Yongin-City (KR)

(72) Inventors: Moon Sung CHOI, Incheon (KR); Young-Jin KIM, Yongin-si (KR); Ji Hong PARK, Suwon-si (KR); Sang Min CHOI, Seoul (KR)

(21) Appl. No.: 14/605,751

(22) Filed: Jan. 26, 2015

(30) Foreign Application Priority Data
Oct. 1, 2014 (KR) 10-2014-0132652

(51) Int. Cl. G06F 3/041; G06F 3/0354

(52) U.S. Cl. CPC G06F 3/041; G06F 3/0416; G06F 3/03545; G06F 2203/04105; G06F 2203/04106; G06F 2203/04103

(57) ABSTRACT

Embodiments relate to a display device including a touch sensor, and more particularly, to a display device including a hybrid touch sensor that can sense a touch and touch pressure by a touch pen. The display device includes: a display panel configured to display an image; and a lower touch sensor unit positioned below the display panel. The lower touch sensor unit includes a sensing electrode layer including a plurality of first sensing electrodes, a conductor, and an elastic layer positioned between the sensing electrode layer and the conductor. The first sensing electrodes form a first touch sensor that is capable of sensing a touch by a stylus pen, and the first sensing electrodes, the conductor, and the elastic layer form a second touch sensor that is capable of sensing touch pressure by an external object.

### CROSS-REFERENCE TO RELATED APPLICATION

This application claims priority to and the benefit of Korean Patent Application No. 10-2014-0132652 filed in the Korean Intellectual Property Office on Oct. 1, 2014, the entire contents of which are incorporated herein by reference.

### BACKGROUND

(a) Technical Field

The present application relates to a display device including a touch sensor, and more particularly, to a display device including a hybrid touch sensor that can sense a touch and touch pressure by a touch pen.

(b) Description of the Related Art

Display devices such as a liquid crystal display and an organic light emitting display, portable transmission devices, and other information processing devices perform functions by using various input devices. Recently, as the input devices, many input devices including a touch sensing apparatus have been used.

The touch sensing function is to determine contact information such as whether an object approaches or contacts a screen and a contact position thereof by sensing a change in pressure, charges, light, and the like which are applied onto the screen of the display device, when a user writes a text or draws a figure by approaching or contacting the screen with a finger or a touch pen. The display device may receive an image signal based on the contact information to display an image.

The touch sensing function may be implemented by a touch sensor. The touch sensor may be classified according to various touch sensing types such as a resistive type, a capacitive type, an electromagnetic resonance (EMR) type, and an optical type.

For example, in the case of the resistive type touch sensor, two electrodes which face each other to be spaced apart from each other may contact each other by pressure due to an external object. When two electrodes contact each other, a change in voltage according to a resistance change at a contact position is recognized and thus the contact position and the like may be determined.

For example, the capacitive type touch sensor includes a sensing capacitor configured by a sensing electrode which may transfer a sensing signal, and may determine whether there is a contact, a contact position, and the like by sensing a change in capacitance of the sensing capacitor generated when a conductor such as a finger approaches the sensor. The capacitive type touch sensor may sense the touch only when a user touches a touch screen and requires a contact by a conductive object.

Such a touch sensor may be embedded in the display device or formed on an outer surface of the display device, or may be used by attaching a separate touch sensor panel to the display device.

In the case of the capacitive type, a change of capacitance of the touch sensor is proportional to a contact area of the conductive object contacting the touch screen, and as a result, as the contact area is increased, a change in signal is increased and thus the touch sensor may sufficiently sense the touch, and as the contact area is decreased, a possibility of a malfunction is increased. Accordingly, even when another object, that is, a stylus pen (also referred to as a touch pen) instead of a finger is to be used, the contact area needs to be set enough to correspond to the contact area of the finger and thus the touch can be normally sensed. Accordingly, in the type of sensing the touch by using the stylus pen, a separate type such as the EMR type instead of the capacitive type may be used.

The above information disclosed in this Background section is only for enhancement of understanding of the background and therefore it may contain information that does not form the prior art that is already known in this country to a person of ordinary skill in the art.

### SUMMARY

Embodiments have been made in an effort to provide a touch sensor having advantages of performing both sensing of a touch position using a stylus pen and sensing of touch pressure by an external object.

Further, embodiments have been made in an effort to reduce a manufacturing cost of the touch sensor that performs both sensing of a touch position using a stylus pen and sensing of touch pressure and minimize addition of layers for sensing the touch pressure to make the thickness of the touch sensor be smaller.

An exemplary embodiment provides a display device including: a display panel configured to display an image; and a lower touch sensor unit positioned below the display panel. The lower touch sensor unit includes a sensing electrode layer including a plurality of first sensing electrodes, a conductor, and an elastic layer positioned between the sensing electrode layer and the conductor. The first sensing electrodes form a first touch sensor that is capable of sensing a touch by a stylus pen, and the first sensing electrodes, the conductor, and the elastic layer form a second touch sensor that is capable of sensing touch pressure by an external object.

The conductor may include a chassis positioned below the elastic layer and receiving or supporting the display panel.

The elastic layer may have an adhesive property.

The first sensing electrodes may be positioned in a touch area corresponding to a display area of the display panel.

The conductor may be positioned between the elastic layer and the display panel and faces the first sensing electrodes.

The display device may further include a driver connected with the plurality of first sensing electrodes through a plurality of signal wires, in which the driver may include an internal switch connected with the plurality of signal wires, a first touch driver connected with the internal switch and configured to drive the first touch sensor, and a second touch driver connected with the internal switch and configured to drive the second touch sensor, and the driver may be formed of an IC chip.

The display device may further include a driver connected with the plurality of first sensing electrodes through a plurality of signal wires, in which the driver may include an external switch connected with the plurality of signal wires, a first touch driver connected with the external switch and configured to drive the first touch sensor, and a second touch driver connected with the external switch and configured to drive the second touch sensor, and each of the first touch driver and the second touch driver may be formed of an driving circuit chip.

The display device may further include an upper touch sensor unit including a third touch sensor positioned on the display panel.

The display device may further include a polarizer positioned on the display panel and positioned on or below the upper touch sensor unit.

Another exemplary embodiment provides a display device including: a display panel configured to display an image; and a lower touch sensor unit positioned below the display panel. The lower touch sensor unit includes a sensing electrode layer including a plurality of first sensing electrodes and at least one second sensing electrode, a conductor, and an elastic layer positioned between the sensing electrode layer and the conductor. The first sensing electrodes form a first touch sensor that is capable of sensing a touch by a stylus pen, and the first sensing electrodes, the conductor, and the elastic layer form a second touch sensor that is capable of sensing touch pressure by an external object.

The second sensing electrode may be positioned in a peripheral area around a touch area with the first sensing electrodes and positioned at a same layer as the first sensing electrodes.

The conductor may include a chassis positioned below the elastic layer and receiving or supporting the display panel.

The elastic layer may have an adhesive property.

The first sensing electrodes may be positioned in the touch area corresponding to a display area of the display panel.

The conductor may be positioned between the elastic layer and the display panel and face the second sensing electrode.

At least one of the conductor and the elastic layer may be positioned in the peripheral area.

The display device may further include a third touch sensor positioned on the display panel.

The display device may further include a polarizer positioned on the display panel and positioned on or below the upper touch sensor unit.

According to the exemplary embodiment, it is possible to provide a touch sensor having advantages of performing both sensing of a touch position using a stylus pen and sensing of touch pressure by an external object, reduce a manufacturing cost of the touch sensor, and minimize addition of layers for sensing the touch pressure to make the thickness of the touch sensor be smaller.

### BRIEF DESCRIPTION OF THE DRAWINGS

FIG. 1 is a cross-sectional view of a display device including a touch sensor according to an exemplary embodiment.

FIG. 2 is a layout view of a sensing electrode layer of a lower touch sensor unit included in the display device including a touch sensor according to an exemplary embodiment.

FIG. 3 is a diagram illustrating a method of sensing touch pressure when an external object is contacted, as a schematic cross-sectional view of the display device including a touch sensor according to an exemplary embodiment.

FIG. 4 is a schematic cross-sectional view of a second touch sensor when the external object does not contact the display device including a touch sensor according to an exemplary embodiment.

FIG. 5 is a schematic cross-sectional view of a modified second touch sensor when the external object contacts the display device including a touch sensor according to an exemplary embodiment.

FIG. 6 is a cross-sectional view of a display device including a touch sensor according to an exemplary embodiment.

FIG. 7 is a layout view of a sensing electrode layer of a lower touch sensor unit included in the display device including a touch sensor according to an exemplary embodiment.

FIG. 8 is a schematic cross-sectional view of a second touch sensor when the external object does not contact the display device including a touch sensor according to an exemplary embodiment.

FIG. 9 is a schematic cross-sectional view of a modified second touch sensor when the external object contacts the display device including a touch sensor according to an exemplary embodiment.

FIG. 10 is a layout view of a sensing electrode layer of a lower touch sensor unit included in the display device including a touch sensor according to an exemplary embodiment.

FIGS. 11 and 12 are cross-sectional views of the display device including a touch sensor according to an exemplary embodiment, respectively.

FIGS. 13 and 14 are block diagrams of a driver of the lower touch sensing unit of the display device including a touch sensor according to an exemplary embodiment, respectively.

### DETAILED DESCRIPTION OF THE EMBODIMENTS

The inventive concept will be described more fully hereinafter with reference to the accompanying drawings, in which exemplary embodiments are shown. As those skilled in the art would realize, the described embodiments may be modified in various different ways, all without departing from the spirit or scope of the inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Accordingly, the drawings and description are to be regarded as illustrative in nature and not restrictive. Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

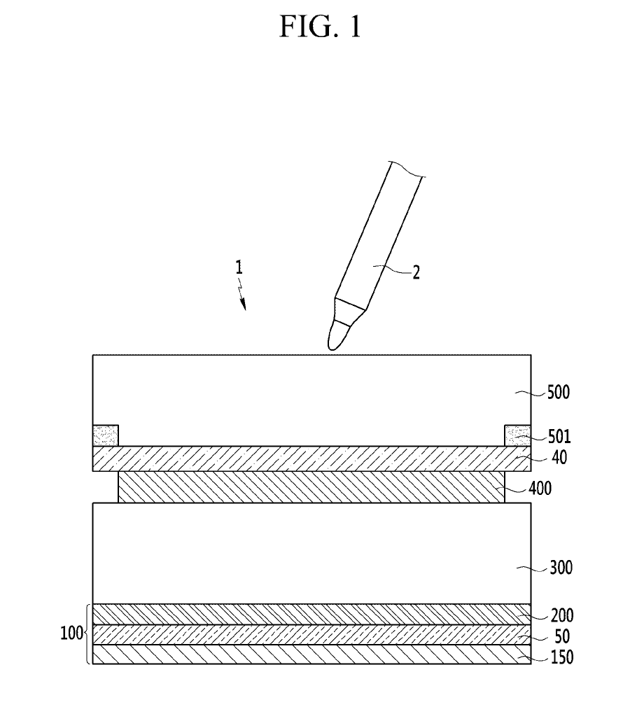

First, a display device including a touch sensor according to an exemplary embodiment will be described with reference to FIGS. 1 to 5.

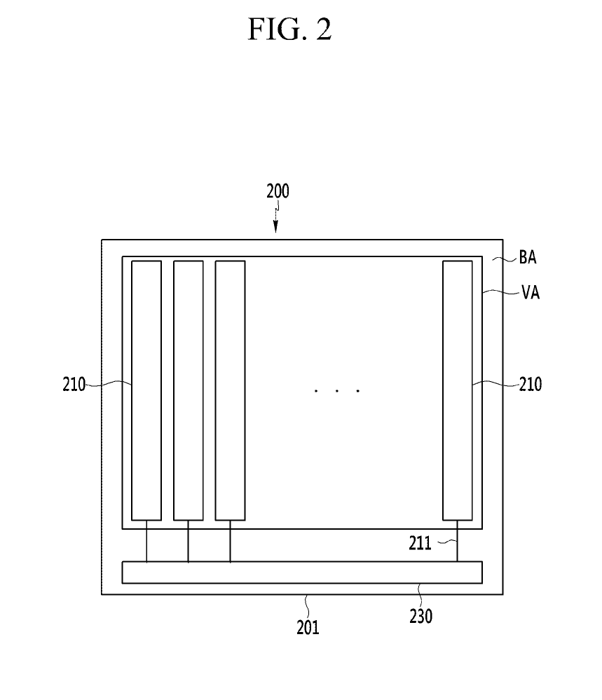

FIG. 1 is a cross-sectional view of a display device including a touch sensor according to an exemplary embodiment, and FIG. 2 is a layout view of a sensing electrode layer of a lower touch sensor unit included in the display device including a touch sensor according to an exemplary embodiment.

Referring to FIG. 1, a display device 1 according to an exemplary embodiment includes a lower touch sensor unit 100 and a display panel 300.

The display panel 300 includes a plurality of signal lines and a plurality of pixels connected thereto and may display an image.

The plurality of pixels is positioned in a display area where the image is displayed. At least one switching element connected to the signal lines and at least one pixel electrode connected thereto may he included. The switching element may include at least one thin film transistor and is controlled depending on a gate signal to transfer a data voltage to the pixel electrode. Each pixel may display an image with desired luminance depending on the data voltage applied to the pixel electrode.

In the exemplary embodiment illustrated in FIG. 1, the image may be displayed toward the upper side of the display 300.

The display panel 300 may be a panel including, for example, a liquid crystal panel or an organic light emitting element. In the case of the liquid crystal panel, a backlight unit supplying light to the display panel 300 may be further included. The backlight unit may be positioned below the display panel 300 in the exemplary embodiment illustrated in FIG. 1 and more particularly, may be positioned between the display panel 300 and the lower touch sensor unit 100.

The lower touch sensor unit 100 includes a lower conductor 150, a sensing electrode layer 200, and an elastic layer 50.

The lower conductor 150 may be a chassis that may receive or support the display panel 300. That is, the lower conductor 150 may use a conductive chassis which is generally included in the display device, not a constituent element added for the display device according to the exemplary embodiment.

When the display device 1 according to the exemplary embodiment includes the backlight unit, the lower conductor 150 may be a chassis that receives the backlight unit together. In this case, the lower conductor 150 may serve to fasten and integrate the display panel 300 and the backlight unit to each other. Further, the lower conductor 150 may include a reflective surface that reflects the light from the backlight unit to transmit the reflected light upwards.

The lower conductor 150 includes a conductive material such as metal of aluminum (Al) and the like in order to emit to the outside heat generated from the display panel 300 or the backlight unit. The lower conductor 150 may further include structures for fixing the display panel 300 or the backlight unit. The lower conductor 150 may serve to protect the display panel 300 and/or the backlight unit from external impact.

Such a lower conductor 150 itself may serve as a lower cover of the display device 1, and a separate insulating cover may be positioned below the lower conductor 150.

The sensing electrode layer 200 is positioned between the lower conductor 150 and the display panel 300.

Referring to FIGS. 1 and 2, the sensing electrode layer 200 includes a sensing electrode 210 for sensing a contact or an approach by an external stylus pen 2.

A plurality of sensing electrodes 210 may be arranged in a predetermined direction and include an input sensing electrode and an output sensing electrode. The sensing electrodes 210 may be positioned in a touch area VA corresponding to the display area of the display panel 300.

The plurality of sensing electrodes 210 may be connected to a pad unit 230 through a plurality of signal wires 211. The signal wire 211 may input an input signal to the sensing electrode 210 or output an output signal to the driver through the pad unit 230. The pad unit 230 may be connected with a driving circuit chip or a driver having a shape of a circuit board or a circuit film and positioned in a peripheral area BA.

The signal wire 211 is positioned on the sensing electrode layer 200 to be positioned at a same layer as the sensing electrode 210 or may not be. When the signal wire 211 is positioned on the sensing electrode layer 200, the signal wire 211 may be formed of the same material as the sensing electrode 210 in the same process or may be formed of a different material from the sensing electrode 210.

The signal wire 211 may be positioned in the peripheral area BA around a touch area VA. The peripheral area BA may be covered by a light blocking member so as not to be viewed from the outside.

The sensing electrode 210 configures a first touch sensor that may sense a touch such as a contact or an approach of the stylus pen 2.

The touch sensing method using the stylus pen 2 may use an electromagnetic resonance. In this case, the stylus pen 2 may include a resonance circuit such as an LRC circuit or an LC circuit.

The input sensing electrode may configure a closed circuit and receive an input signal of a predetermined frequency from the driver through the signal wire 211 to generate an electromagnetic wave. When the stylus pen 2 approaches the display device 1, a resonance circuit including, for example, a capacitor and a coil of the stylus pen 2 generates the resonance by the electromagnetic wave generated by the input sensing electrode to generate a response electromagnetic wave.

The output sensing electrode may configure a closed circuit and receive the response electromagnetic wave from the stylus pen 2 to generate the output signal and transfer the generated output signal to the driver through the signal wire 211. The driver may process the output signal to sense a touch position.

The input sensing electrodes and the output sensing electrodes may be alternately arranged.

The first touch sensor using the stylus pen 2 may sense pressure of the touch by the stylus pen 2. In detail, a capacitance of the capacitor included in the stylus pen 2 is changed according to the pressure generated when the stylus pen 2 presses the display device 1, and a change in the response electromagnetic wave is caused according to the changed capacitance of the capacitor to sense the touch pressure by the stylus pen 2.

The sensing electrode layer 200 may be positioned on a circuit board 201. The circuit board 201 may be formed of plastic such as polyimide, glass, or the like and may be flexible or rigid. The pad unit 230 connected with the signal wire 211 may be formed on the circuit board 201.

The circuit board 201 may include a touch area VA corresponding to the display area of the display panel 300 and a peripheral area BA therearound.

The elastic layer 50 is positioned between the lower conductor 150 and the sensing electrode layer 200. The elastic layer 50 has elasticity so that after the elastic layer 50 is compressed by external pressure and then the pressure is removed, the elastic layer 50 can be restored to an original state.

The elastic layer 50 may also have an adhesive function. In this case, the elastic layer 50 may be an adhesive tape shape. Particularly, the sensing electrode layer 200 needs to be attached to the lower conductor 150, and when an elastic adhesive tape is used as the adhesive tape between the sensing electrode layer 200 and the lower conductor 150, a separate layer for the elastic layer 50 does not need to be added. In this case, the elastic layer 50 may he a silicon-based elastic adhesive layer or elastic tape.

The lower conductor 150, the elastic layer 50, and the sensing electrode 210 configure together a second touch sensor which is a pressure sensing sensor.

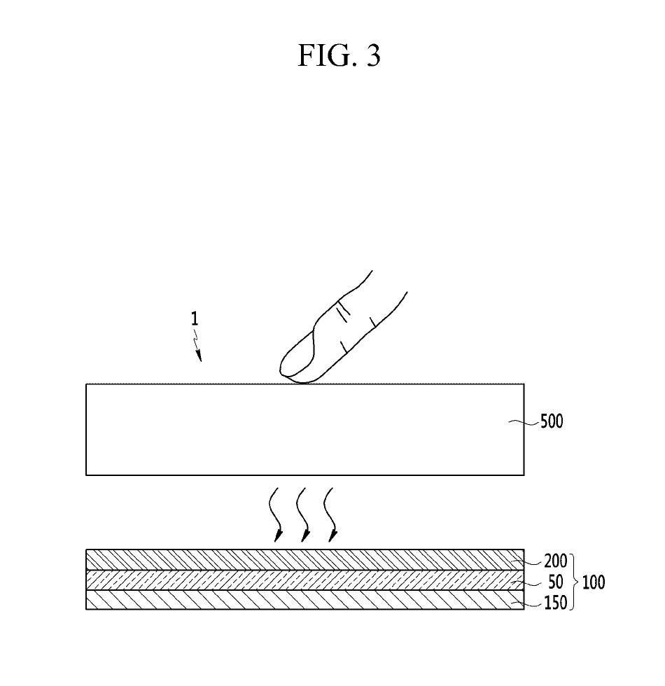

Such a second touch sensor will be described with reference to FIGS. 3 to 5.

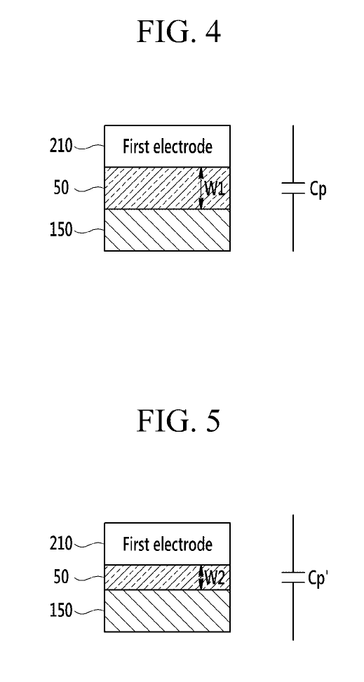

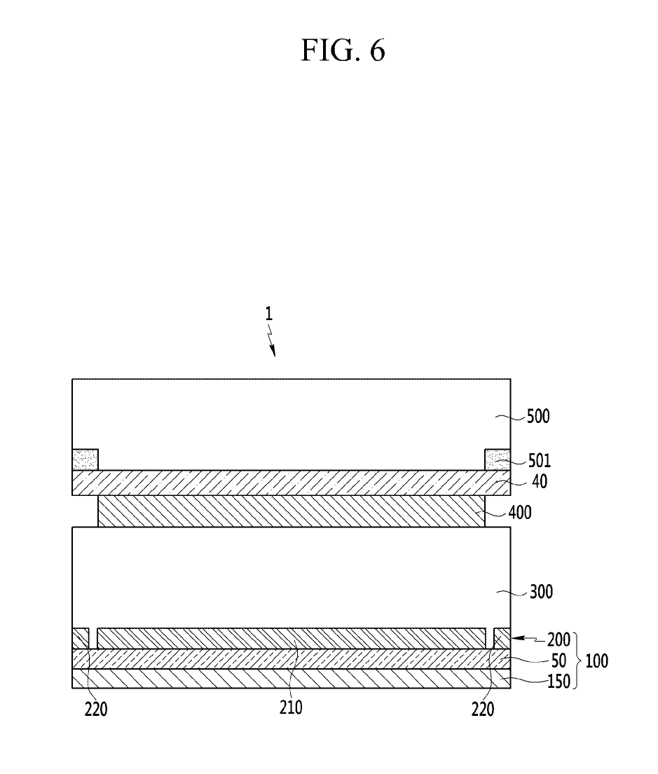

FIG. 3 is a diagram illustrating a method of sensing touch pressure when an external object is contacted, as a schematic cross-sectional view of the display device including a touch sensor according to an exemplary embodiment, FIG. 4 is a schematic cross-sectional view of a second touch sensor when the external object does not contact the display device including a touch sensor according to an exemplary embodiment, and FIG. 5 is a schematic cross-sectional view of a modified second touch sensor when the external object contacts the display device including a touch sensor according to an exemplary embodiment.

A second touch sensor may sense touch pressure when a stylus pen or an external object which is not the stylus pen contacts and presses the display device 1.

Referring to FIG. 4, when there is no contact of the external object, there is no pressure applied to the display device 1 in a vertical direction, and as a result, the elastic layer 50 between the sensing electrode 210 configuring the second touch sensor and the lower conductor 150 is not deformed and thus a first width W1 in a vertical direction is maintained. Here, a sensing capacitor formed by the sensing electrode 210 and the lower conductor 150 with the elastic layer 50 as a dielectric material may have a predetermined first capacitance Cp.

As illustrated in FIG. 3, when an external object such as a finger contacts the upper surface of the display device 1, the touch pressure by the contact is transferred to the lower touch sensor unit 100 and the elastic layer 50 of the second touch sensor is deformed.

Then, as illustrated in FIG. 5, the vertical width of the elastic layer 50 becomes a second width W2, and the second width W2 is smaller than the first width W1. Accordingly, the capacitance of the sensing capacitor formed by the sensing electrode 210 and the lower conductor 150 with the elastic layer 50 as a dielectric material becomes a second capacitance CP′ which is larger than the first capacitance Cp.

The driver connected with the second touch sensor may sense an intensity of the touch pressure depending on a difference between the first capacitance Cp and the second capacitance CP′. That is, it is determined that as the difference between the first capacitance Cp and the second capacitance CP′ is increased, the touch pressure is large.

Since the second touch sensor described above reuses the sensing electrode 210 and the lower conductor 150 of the first touch sensor using the stylus pen 2 and adds only the elastic layer 50, a process of forming at least two electrode layers for forming a general pressure sensing sensor may be omitted, thereby reducing a manufacturing cost. Further, since there is no electrode layer to be additionally formed on the elastic layer 50, an additional second touch sensor may be added to the display device without making the display device thicker.

Furthermore, as described above, when the elastic layer 50 is formed with an elastic adhesive tape for adhesion between the first touch sensor and the lower conductor 150, a separate layer for the elastic layer 50 does not need to be added and the thickness of the display device may be further decreased.

Referring back to FIG. 1, the display device 1 according to the exemplary embodiment may further include a polarizer 40 positioned on the display panel 300. When the display panel 300 is a liquid crystal panel, the polarizer 40 controls transmittance of an image of which a polarization direction is changed according to an input image signal in a liquid crystal layer to view a desired image. When the display panel 300 is an organic light emitting panel, the polarizer 40 may serve to reduce reflection of external light to enhance quality of the display image.

Referring to FIG. 1, the display device 1 according to the exemplary embodiment may further include a cover window 500 positioned on the display panel 300. The cover window 500 may be made of an insulating material such as plastic or glass. The cover window 500 may be flexible or rigid. The surface of the cover window 500 may be a touch surface of the display device 1 which an external object may contact.

A light blocking member 501 may be positioned at an edge of the lower surface of the cover window 500. The light blocking member 501 exposes the display area or the touch area VA of the display panel 300 and allows the peripheral area BA not to be viewed from the outside.

Referring to FIG. 1, the display device 1 according to the exemplary embodiment may further include an upper touch sensor unit 400 positioned on the display panel 300. For example, the upper touch sensor unit 400 may be positioned between the polarizer 40 and the display panel 300 as illustrated in FIG. 1. In this case, the upper touch sensor unit 400 may be directly formed on the upper surface of the display panel 300 or formed on a separate film or plate and then attached to the front surface of the display panel 300.

The polarizer 40 may be attached to the upper surface of the upper touch sensor unit 400. As such, the cover window 500 may be attached to the upper surface of the upper touch sensor unit 400 attached with the polarizer 40 by using an adhesive such as an optically clear adhesive (OCA).

The upper touch sensor unit 400 may include various types of third touch sensors, and particularly, the third touch sensor may be a capacitive type. The third touch sensor may sense a touch position and the like when an external object such as a finger other than the stylus pen 2 is touched.

The third touch sensor may include a plurality of touch electrodes containing transparent conducting materials such as ITO or IZO, a silver nano wire (AgNW) and a metal mesh.

The touch electrode receives a signal from the driver connected with the third touch sensor and may output the signal changed according to the contact of the external object such as a finger. In this case, the external object and the touch electrode of the third touch sensor form a capacitor, and as a result, the signal from the touch electrode is changed to be output. The driver may sense contact information such as a touch position based on the output signal. In the case of the capacitive type, the object of which the third touch sensor may sense the touch may be a conductor such as a finger which may form a capacitor together with the touch electrode of the third touch sensor.

Unlike those illustrated in FIG. 1, positions of the upper touch sensor unit 400 and the polarizer 40 may be changed to each other. That is, the upper touch sensor unit 400 may be positioned on the polarizer 40. When there is the cover window 500, the upper touch sensor unit 400 may be positioned between the polarizer 40 and the cover window 500. In this case, the upper touch sensor unit 400 may be directly formed on the upper surface of the polarizer 40 and then attached to the display panel 300, formed on a separate film or plate and then attached on the upper surface of the display panel 300 attached with the polarizer 40, or formed on the lower surface of the cover window 500 and then attached on the display panel 300.

According to the exemplary embodiment, the touch position and/or the touch pressure using the stylus pen 2 may be sensed by using the first touch sensor using the stylus pen 2, and the touch pressure may be sensed even when another object other than the stylus pen 2 is touched. Since the second touch sensor for sensing the touch pressure by another object other than the stylus pen 2 uses an existing constituent element of the display panel 1 and a constituent element of the first touch sensor, the thickness of the display device 1 is not increased, and there is little addition of the manufacturing process and the manufacturing cost.

Since the second touch sensor for sensing the touch pressure is positioned below the display panel 300, the second touch sensor does not block a path of light of the image and thus an optical characteristic of the image displayed on the display panel 300 may not deteriorate.

In addition, the third touch sensor that may sense the touch of the conductor such as a finger is formed on the display panel 300 to sense the touch position and the like of the external object such as a finger other than the stylus pen 2. As described above, the touch pressure of the external object such as a finger other than the stylus pen 2 may be sensed by the second touch sensor.

When the third touch sensor is directly formed on the outer surface of the display panel 300 (on-cell type), a gap between the third touch sensor and the display panel 300 may be reduced as compared with a type attached with the touch panel in the related art (add on type), thereby reducing an error of the touch information.

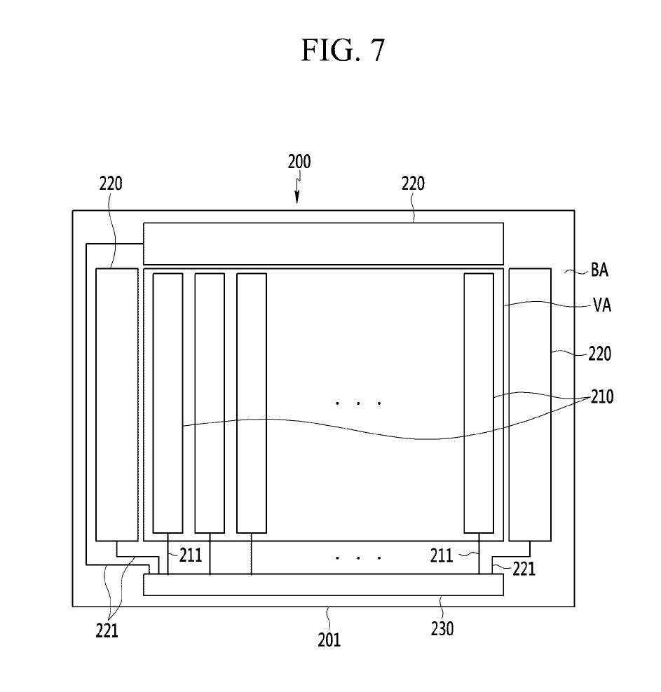

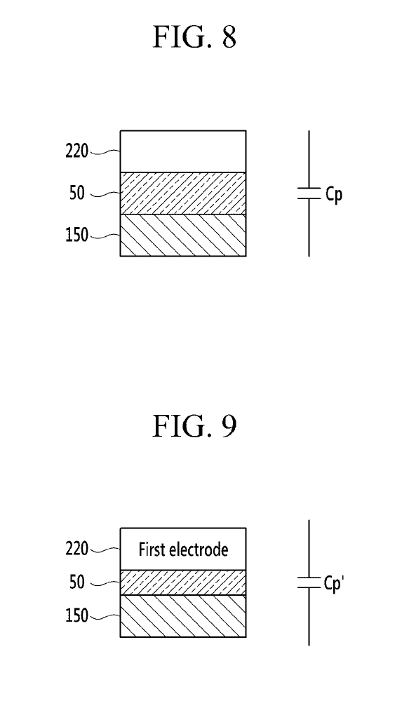

Hereinafter, a display device including a touch sensor according to an exemplary embodiment will be described with reference to FIGS. 6 and 7 together with the drawings described above. The same constituent elements as the exemplary embodiments described above designate the same reference numerals, and the duplicated description is omitted.

FIG. 6 is a cross-sectional view of a display device including a touch sensor according to an exemplary embodiment, and FIG. 7 is a layout view of a sensing electrode layer of a lower touch sensor unit included in the display device including a touch sensor according to an exemplary embodiment.

Referring to FIGS. 6 and 7, the display device 1 according to the exemplary embodiment is almost the same as the display device 1 according to the exemplary embodiment described above, but a structure of the lower touch sensor unit 100 may be different.

The lower touch sensor unit 100 includes a lower conductor 150, a sensing electrode layer 200, and an elastic layer 50.

The sensing electrode layer 200 includes a sensing electrode 210 for sensing a contact or an approach by the stylus pen 2 and at least one pressure sensing electrode 220.

The sensing electrode 210 configures a first touch sensor that may sense a touch such as a contact or an approach of the stylus pen 2.

A plurality of sensing electrodes 210 may be arranged in a predetermined direction and include an input sensing electrode and an output sensing electrode. The sensing electrodes 210 may be positioned in a touch area VA corresponding to the display area of the display panel 300.

The plurality of sensing electrodes 210 may be connected to a driver for the first touch sensor through a plurality of signal wires 211. The signal wire 211 connects each sensing electrode 210 and the driver for the first touch sensor to input an input signal to the sensing electrode 210 or output an output signal to the driver.

One end of the signal wire 211 is connected to the sensing electrode 210 and the other end thereof may be connected to a pad unit 230. The pad unit 230 may be connected with a driving circuit chip for the first touch sensor or a driver having a shape of a circuit board or a circuit film and positioned in a peripheral area BA.

Since features of the first touch sensor are the same as those described above, a more detailed description will be omitted.

The pressure sensing electrode 220 may be positioned at a same layer as the sensing electrode 210. Further, the pressure sensing electrode 220 may include the same material as the sensing electrode 210, and in this case, may be formed in the same process as the sensing electrode 210.

Referring to FIG. 7, when the pad unit 230 is positioned at one side of the peripheral area BA, the pressure sensing electrode 220 may be positioned at a side where the pad unit 230 is not positioned in the peripheral area BA. When the plurality of pressure sensing electrodes 220 is formed, each pressure sensing electrode 220 may be positioned in the peripheral area BA of a different side.

The pressure sensing electrode 220 may be connected to the pad unit 230 through the signal wire 221. The signal wire 221 may input an input signal to the pressure sensing electrode 220 or output an output signal to the driver through the pad unit 230.

The signal wire 221 is positioned on the sensing electrode layer 200 to be positioned at a same layer as the sensing electrode 210 or the pressure sensing electrode 220 or may not be. When the signal wire 221 is positioned on the sensing electrode layer 200, the signal wire 221 may be formed of the same material as the sensing electrode 210 or the pressure sensing electrode 220 in the same process or may be formed of a different material from the sensing electrode 210 or the pressure sensing electrode 220.

The signal wire 221 may be positioned in the peripheral area BA.

The sensing electrode layer 200 may be positioned on a circuit board 201.

The elastic layer 50 is positioned between the lower conductor 150 and the sensing electrode layer 200 like the exemplary embodiment described above. The elastic layer 50 has elastic force in which the elastic layer 50 is compressed by external pressure and then restored to an original state when the pressure is removed. The elastic layer 50 may also be positioned on all surfaces between the lower conductor 150 and the sensing electrode layer 200 and positioned only between the pressure sensing electrode 220 and the lower conductor 150.

The elastic layer 50 may have an adhesive function between the sensing electrode layer 200 and the lower conductor 150. In this case, the elastic layer 50 may be an adhesive tape shape. Further, the elastic layer 50 may be positioned on all surfaces below the sensing electrode layer 200. The elastic layer 50 may include a silicon-based elastic adhesive layer or elastic tape.

Unlike those illustrated in FIG. 6, the elastic layer 50 may be positioned only between the pressure sensing electrode 220 and the lower conductor 150 in the sensing electrode layer 200.

The lower conductor 150, the elastic layer 50, and the sensing electrode 220 configure together a second touch sensor which is a pressure sensing sensor.

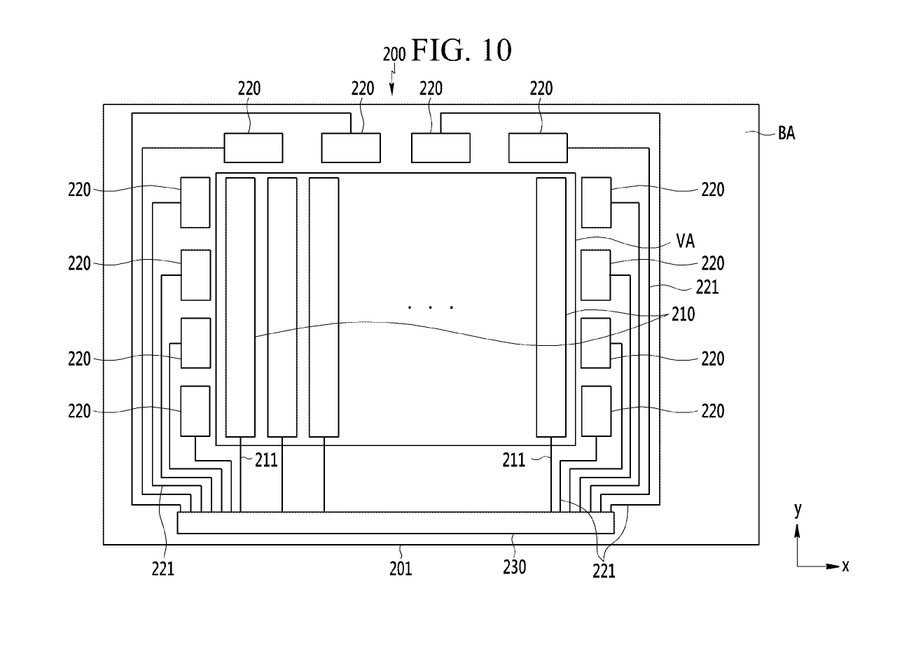

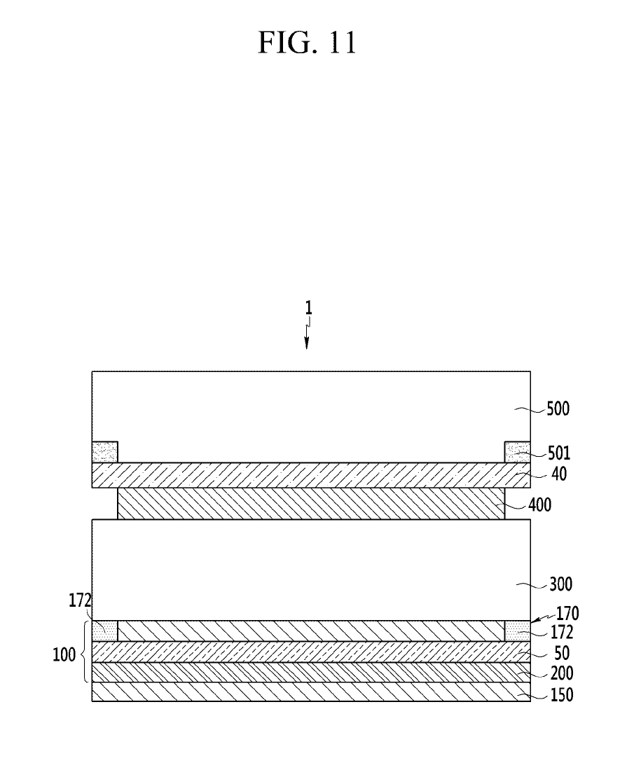

Then, the second touch sensor according to the exemplary embodiment will be described with reference to FIGS. 8 and 9 in addition to FIGS. 6 and 7.

FIG. 8 is a schematic cross-sectional view of a second touch sensor when the external object does not contact the display device including a touch sensor according to an exemplary embodiment, and FIG. 9 is a schematic cross-sectional view of a modified second touch sensor when the external object contacts the display device including a touch sensor according to an exemplary embodiment.

A second touch sensor may sense touch pressure when a stylus pen or an external object which is not the stylus pen contacts and presses the display device 1.

Referring to FIG. 8, when there is no contact of the external object, there is no pressure applied to the display device 1 in a vertical direction, and as a result, the elastic layer 50 between the pressure sensing electrode configuring the second touch sensor and the lower conductor 150 is not deformed. At this time, a sensing capacitor formed by the pressure sensing electrode 220 and the lower conductor 150 with the elastic layer 50 as a dielectric material may have a predetermined first capacitance Cp.

When an external object such as a finger contacts the upper surface of the display device 1, the touch pressure by the contact is transferred to the lower touch sensor unit 100 and the elastic layer 50 of the second touch sensor is deformed. Then, as illustrated in FIG. 9, a vertical width of the elastic layer 50 is decreased and thus the capacitance of the sensing capacitor formed by the sensing electrode 220 and the lower conductor 150 using the elastic layer 50 becomes a second capacitance Cp′ which is larger than the first capacitance Cp.

The driver connected with the second touch sensor may sense an intensity of the touch pressure depending on a difference between the first capacitance Cp and the second capacitance CP′.

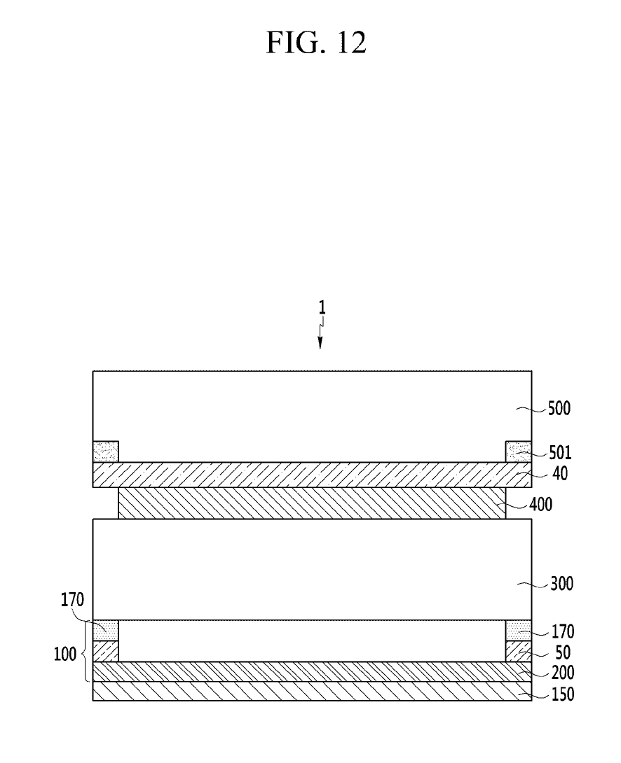

A display device including a touch sensor according to an exemplary embodiment will be described with reference to FIGS. 10 to 12 together with the drawings described above. The same constituent elements as the exemplary embodiments described above designate the same reference numerals, and the duplicated description is omitted.

FIG. 10 is a layout view of a sensing electrode layer of a lower touch sensor unit included in the display device including a touch sensor according to an exemplary embodiment.

Referring to FIG. 10, the display device 1 according to the exemplary embodiment is almost the same as the display device according to the exemplary embodiment illustrated in FIGS. 6 and 7, but a structure of the pressure sensing electrode 220 included in the lower touch sensor unit 100 may be different.

A plurality of pressure sensing electrodes 220 may be positioned at one side of the peripheral area BA. FIG. 10 illustrates an example in which four pressure sensing electrodes 220 are disposed at one side of the peripheral area BA, but the inventive concept is not limited thereto. Further, FIG. 10 illustrates an example in which all the pressure sensing electrodes 220 are positioned at the remaining sides except for the side where the pad unit 230 is positioned, among four sides of the peripheral area BA, but the inventive concept is not limited thereto, and at least one pressure sensing electrode 220 may be positioned only at one side.

The plurality of pressure sensing electrodes 220 positioned at one side of the peripheral area BA may be separated from each other to be arranged in an x direction and/or a y direction. Each pressure sensing electrode 220 may be connected to the pad unit 230 through the signal wire 221 to receive or output the signal.

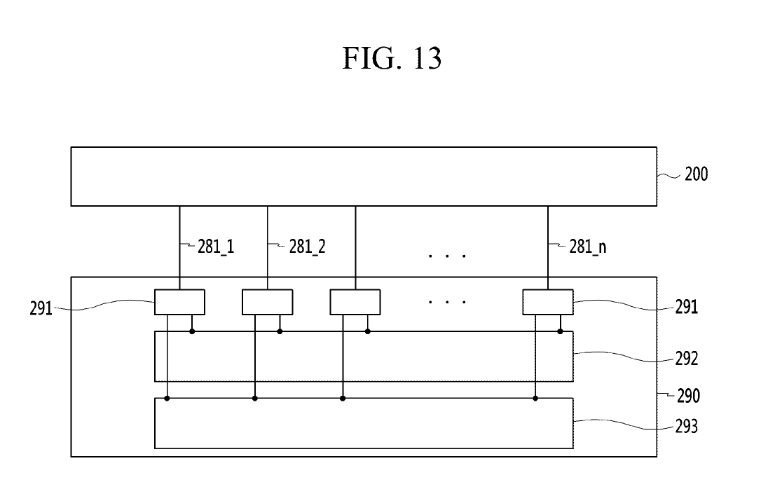

FIG. 11 is a cross-sectional view of the display device including a touch sensor according to an exemplary embodiment.

Referring to FIG. 11, the display device including a touch sensor according to an exemplary embodiment is almost the same as the exemplary embodiment illustrated in FIGS. 6 to 9 described above, but a structure of the lower touch sensor unit 100 may be different.

The lower touch sensor unit 100 does not include the lower conductor 150, but may include the sensing electrode layer 200, the elastic layer 50, and an upper electrode layer 170.

The sensing electrode layer 200 may include a sensing electrode 210 for sensing a contact or an approach by the stylus pen 2 and at least one pressure sensing electrode 220 like the sensing electrode layer 200 of the exemplary embodiment illustrated in FIGS. 6 and 7.

The upper electrode layer 170 is positioned between the display panel 300 and the elastic layer 50. The upper electrode layer 170 includes at least one upper conductor 172. The upper conductor 172 may he positioned at a portion which faces a region with the pressure sensing electrode 220 of the sensing electrode layer 200 as illustrated in FIG. 11. In this case, the upper conductor 172 may be positioned in the peripheral area BA.

The upper electrode layer 170 may include a circuit board with the upper conductor 172. The circuit board may include an insulating material such as plastic such as polyimide or glass.

The elastic layer 50 is positioned between the upper electrode layer 170 and the sensing electrode layer 200. The elastic layer 50 has elastic force in which the elastic layer 50 is compressed by external pressure and then restored to an original state when the pressure is removed. The elastic layer 50 may have an adhesive property. In this case, the elastic layer 50 may be an elastic adhesive tape.

The elastic layer 50 may be positioned on all the surfaces of the sensing electrode layer 200 as illustrated in FIG. 11, and unlike this, may be positioned only between the upper conductor 172 and the pressure sensing electrode 220.

The upper conductor 172, the elastic layer 50, and the pressure sensing electrode 220 configure together the second touch sensor which is the pressure sensing sensor to sense a change in capacitance of the sensing capacitor by deformation of the elastic layer 50 and thus sense the touch pressure by the external object.

According to another exemplary embodiment, unlike those illustrated in FIG. 11, the upper conductor 172 may be formed on the front surface of the elastic layer 50. In this case, the upper conductor 172 may include a portion which faces the sensing electrode 210 in addition to the pressure sensing electrode 220 of the sensing electrode layer 200.

The structure of the sensing electrode layer 200 of the display device according to another exemplary embodiment may be the same as that of the sensing electrode layer 200 of the exemplary embodiment illustrated in FIGS. 1 and 2 unlike those illustrated in FIG. 11. In this case, the upper conductor 172 of the upper electrode layer 170 may be formed to face the sensing electrode 210 of the sensing electrode layer 200 unlike those illustrated in FIG. 11. In this case, the upper conductor 172, the elastic layer 50, and the sensing electrode 210 configure together the second touch sensor which is the pressure sensing sensor to sense a change in capacitance of the sensing capacitor by deformation of the elastic layer 50 and thus sense the touch pressure by the external object.

FIG. 12 is a cross-sectional view of a display device including a touch sensor according to an exemplary embodiment.

Referring to FIG. 12, the display device including the touch sensor according to the exemplary embodiment is almost the same as that of the exemplary embodiment illustrated in FIG. 11, but structures of the upper electrode layer 170 and the elastic layer 50 may be different therefrom.

The lower touch sensor unit 100 does not include the lower conductor 150, but may include the sensing electrode layer 200, the elastic layer 50, and the upper electrode layer 170 like the exemplary embodiment illustrated in FIG. 11.

The sensing electrode layer 200 may include a sensing electrode 210 for sensing a contact or an approach by the stylus pen 2 and at least one pressure sensing electrode 220 like the sensing electrode layer 200 of the exemplary embodiment illustrated in FIGS. 6 and 7.

Unlike those illustrated in FIG. 11, the upper electrode layer 170 is not formed on the front surface below the display panel 300, but is formed only on the outside, that is, the peripheral area BA to face the pressure sensing electrode 220. Accordingly, the upper electrode layer 170 may not face the sensing electrode 210 of the sensing electrode layer 200.

The upper electrode layer 170 includes at least one upper conductor (not illustrated) facing the pressure sensing electrode 220 of the sensing electrode layer 200.

The upper electrode layer 170 may include a circuit board with the upper conductor.

The elastic layer 50 is positioned between the upper electrode layer 170 and the sensing electrode layer 200 and is not formed on the front surface of the sensing electrode layer 200 unlike those illustrated in FIG. 11 and may be positioned only in the peripheral area BA. The elastic layer 50 has elastic force in which the elastic layer 50 is compressed by external pressure and then restored to an original state when the pressure is removed. The elastic layer 50 may have an adhesive property.

The upper conductor of the upper electrode layer 170, the elastic layer 50, and the pressure sensing electrode 220 configure together the second touch sensor which is the pressure sensing sensor to sense a change in capacitance of the sensing capacitor by deformation of the elastic layer 50 and thus sense the touch pressure by the external object.

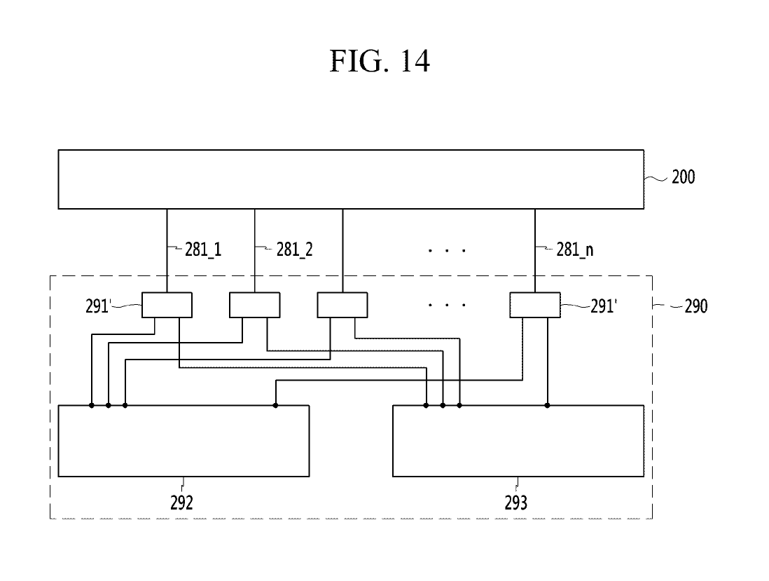

Hereinafter, the drivers for the first touch sensor and the second touch sensor included in the display device according to the exemplary embodiment will be described with reference to FIGS. 13 and 14 in addition to the drawings described above.

FIGS. 13 and 14 are block diagrams of a driver of the lower touch sensing unit of the display device including a touch sensor according to an exemplary embodiment, respectively.

The display device according to the exemplary embodiment may simultaneously configure one terminal of a sensing capacitor of the second touch sensor which is the pressure sensing sensor while configuring the first touch sensor of which the sensing electrode 210 of the sensing electrode layer 200 may sense the contact by the stylus pen like the exemplary embodiment illustrated in FIGS. 1 and 2. Further, the other terminal of the sensing capacitor of the second touch sensor may include the lower conductor 150 like the exemplary embodiments illustrated in FIGS. 1 to 10, and may include a separate upper conductor of the upper electrode layer 170 on the elastic layer 50 like the exemplary embodiment illustrated in FIGS. 11 and 12.

First, referring to FIG. 13, the sensing electrode layer 200 with the first touch sensor and the second touch sensor may be connected with a driver 290 through a plurality of connecting wires 281_1, 281_2, . . . , 281_{—}n. Particularly, the connecting wires 281_1, 281_2, . . . , 281_{—}n may be connected with the pad unit 230 of the sensing electrode layer 200.

The driver 290 includes an internal switch 291, a first touch driver 292, and a second touch driver 293. The internal switch 291 is connected with the connecting wires 281_1, 281_2, . . . , 281_{—}n. The internal switch 291 may be prepared in plural or not as illustrated in the drawing.

When the display device operates in a touch mode using the first touch sensor, the internal switch 291 selects the first touch driver 292 to be connected with the connecting wires 281_1, 281_2, . . . , 281_{—}n. Accordingly, the first touch driver 292 may output a signal through the connecting wires 281_1, 281_2, . . . , 281_{—}n or receive and process the signal.

When the display device operates in a touch mode using the second touch sensor, the internal switch 291 selects the second touch driver 293 to be connected with the connecting wires 281_1, 281_2, . . . , 281_{—}n. Accordingly, the second touch driver 293 may output a signal through the connecting wires 281_1, 281_2, . . . , 281_{—}n or receive and process the signal.

When the first touch sensor and the second touch sensor share and use the sensing electrode 210 like the exemplary embodiment illustrated in FIGS. 1 and 2, an operation period of the touch mode using the first touch sensor and an operating period of the touch mode using the second touch sensor need to be separated from each other. In this case, the display device selects the first touch driver 292 or the second touch driver 293 though the internal switch 291 included in the driver 290 according to the exemplary embodiment illustrated in FIG. 13 to operate in each touch mode.

The driver 290 according to the exemplary embodiment illustrated in FIG. 13 may be formed of an IC chip, but is not limited thereto. As such, when the second touch driver 293 is formed in the same IC chip as the first touch driver 292, the second touch driver 293 needs not to use a separate driving circuit chip for the third touch sensor, thereby reducing a manufacturing process and a manufacturing cost of the display device.

Next, referring to FIG. 14, the sensing electrode layer 200 with the first touch sensor and the second touch sensor may be connected with the driver 290 through the plurality of connecting wires 281_1, 281_2, . . . , 281_{—}n. Particularly, the connecting wires 281_1, 281_2, . . . , 281_{—}n may be connected with the pad unit 230 of the sensing electrode layer 200.

The driver 290 includes an external switch 291′, the first touch driver 292, and the second touch driver 293. Each external switch 291′ is connected with the connecting wires 281_1, 281_2, . . . , 281_{—}n. The external switch 291′ may be prepared in plural or not as illustrated in the drawing.

When the display device operates in a touch mode using the first touch sensor, the external switch 291′ selects the first touch driver 292 to be connected with the connecting wires 281_1, 281_2, . . . , 281_{—}n. Accordingly, the first touch driver 292 may output a signal through the connecting wires 281_1, 281_2, . . . , 281_{—}n or receive and process the signal.

When the display device operates in a touch mode using the second touch sensor, the external switch 291′ selects the second touch driver 293 to be connected with the connecting wires 281_1, 281_2, . . . , 281_{—}n. Accordingly, the second touch driver 293 may output a signal through the connecting wires 281_1, 281_2, . . . , 281_{—}n or receive and process the signal.

When the first touch sensor and the second touch sensor share and use the sensing electrode 210 like the exemplary embodiment illustrated in FIGS. 1 and 2, an operation period of the touch mode using the first touch sensor and an operating period of the touch mode using the second touch sensor need to be separated from each other. In this case, the display device selects the first touch driver 292 or the second touch driver 293 though the external switch 291′ included in the driver 290 according to the exemplary embodiment illustrated in FIG. 14 to operate in each touch mode.

The first touch driver 292 and the second touch driver 293 may be formed of separate IC chips, respectively, and the external switches 291′ may be separately formed outside of the first touch driver 292 and the second touch driver 293.

While the inventive concept has been described in connection with what is presently considered to he practical exemplary embodiments, it is to he understood that the inventive concept is not limited to the disclosed embodiments, but, on the contrary, is intended to cover various modifications and equivalent arrangements included within the spirit and scope of the appended claims.

### DESCRIPTION OF SYMBOLS

40: Polarizer

50: Elastic layer

100: Lower touch sensor unit

150: Lower conductor

170: Upper electrode layer

200: Sensing electrode layer

201: Circuit board

210: Sensing electrode

211, 221: Signal wire

220: Pressure sensing electrode

230: Pad unit

290: Driver

291: Internal switch

291′: External switch

300: Display panel

400: Upper touch sensor unit

500: Cover window

501: Light blocking member

What is claimed is:

1. A display device, comprising:
a display panel configured to display an image; and
a lower touch sensor unit positioned below the display panel,
wherein the lower touch sensor unit includes a sensing electrode layer including a plurality of first sensing electrodes, a conductor, and an elastic layer positioned between the sensing electrode layer and the conductor,
the first sensing electrodes form a first touch sensor that is capable of sensing a touch by a stylus pen, and
the first sensing electrodes, the conductor, and the elastic layer form a second touch sensor that is capable of sensing touch pressure by an external object.

2. The display device of claim 1, wherein:
the conductor includes a chassis positioned below the elastic layer and receiving or supporting the display panel.

3. The display device of claim 2, wherein:
the elastic layer has an adhesive property.

4. The display device of claim 2, wherein:
the first sensing electrodes are positioned in a touch area corresponding to a display area of the display panel.

5. The display device of claim 1, wherein:
the conductor is positioned between the elastic layer and the display panel and faces the first sensing electrodes.

6. The display device of claim 5, wherein:
the elastic layer has an adhesive property.

7. The display device of claim 1, further comprising:
a driver connected with the plurality of first sensing electrodes through a plurality of signal wires,
wherein the driver includes an internal switch connected with the plurality of signal wires, a first touch driver connected with the internal switch and configured to drive the first touch sensor, and a second touch driver connected with the internal switch and configured to drive the second touch sensor, and
the driver is formed of an IC chip.

8. The display device of claim 1, further comprising:
a driver connected with the plurality of first sensing electrodes through a plurality of signal wires,
wherein the driver includes an external switch connected with the plurality of signal wires, a first touch driver connected with the external switch and configured to drive the first touch sensor, and a second touch driver connected with the external switch and configured to drive the second touch sensor, and
each of the first touch driver and the second touch driver is formed of an driving circuit chip.

9. The display device of claim 1, further comprising:
an upper touch sensor unit including a third touch sensor positioned on the display panel.

10. The display device of claim 9, further comprising:
a polarizer positioned on the display panel and positioned on or below the upper touch sensor unit.

11. A display device, comprising:
a display panel configured to display an image; and
a lower touch sensor unit positioned below the display panel,
wherein the lower touch sensor unit includes a sensing electrode layer including a plurality of first sensing electrodes and at least one second sensing electrode, a conductor, and an elastic layer positioned between the sensing electrode layer and the conductor,
the first sensing electrodes form a first touch sensor that is capable of sensing a touch by a stylus pen, and
the first sensing electrodes, the conductor, and the elastic layer form a second touch sensor that is capable of sensing touch pressure by an external object.

12. The display device of claim 11, wherein:
the second sensing electrode is positioned in a peripheral area around a touch area with the first sensing electrodes and positioned at a same layer as the first sensing electrodes.

13. The display device of claim 12, wherein:
the conductor includes a chassis positioned below the elastic layer and receiving or supporting the display panel.

14. The display device of claim 13, wherein:
the elastic layer has an adhesive property.

15. The display device of claim 13, wherein:
the first sensing electrodes are positioned in the touch area corresponding to a display area of the display panel.

16. The display device of claim 12, wherein:
the conductor is positioned between the elastic layer and the display panel and faces the second sensing electrode.

17. The display device of claim 16, wherein:
at least one of the conductor and the elastic layer is positioned in the peripheral area.

18. The display device of claim 17, wherein:
the elastic layer has an adhesive property.

19. The display device of claim 11, further comprising:
an upper touch sensor unit including a third touch sensor positioned on the display panel.

20. The display device of claim 19, further comprising:
a polarizer positioned on the display panel and positioned on or below the upper touch sensor unit.
